(19) United States
(12) Patent Application Publication
(10) Pub. No.: US 2025/0274361 A1
(43) Pub. Date: Aug. 28, 2025

(54) INFORMATION PROCESSING APPARATUS, INFORMATION PROCESSING SYSTEM, INFORMATION PROCESSING METHOD, AND STORAGE MEDIUM

(71) Applicant: CASIO COMPUTER CO., LTD., Tokyo (JP)

(72) Inventor: Chiori SUGAWA, Tokyo (JP)

(21) Appl. No.: 19/060,178

(22) Filed: Feb. 21, 2025

(30) Foreign Application Priority Data
Feb. 28, 2024 (JP) 2024-028519

(51) Int. Cl. H04L 43/04; H04W 76/15

(52) U.S. Cl. CPC H04L 43/04; H04W 76/15

(57) ABSTRACT

An information processing apparatus includes, a display; a communicator; and a processor. The processor is configured to, in a case that the communication connection is established with a first external device with a first connection method, acquire usage log information at a timing that the communication connection is established, in a case that the communication connection is established with a second external device with a second connection method, acquire the usage log information at predetermined intervals, and in a case that the setting information of the display order of each of the external devices is updated based on the acquired usage log information of each of the external devices, change the display order of display target information based on the updated setting information of the display order of each of the external devices, and display the display target information on the display as a list.

### CROSS-REFERENCE TO RELATED APPLICATIONS

This application is based upon and claims the benefit of priority from the prior Japanese Patent Application No. 2024-028519, filed Feb. 28, 2024, which is hereby incorporated by reference herein in its entirety.

### BACKGROUND OF THE INVENTION

### Field of the Invention

The present disclosure relates to an information processing apparatus, an information processing system, an information processing method, and a storage medium.

### Description of the Related Art

For example, as disclosed in JP 2016-42304, there is a conventional technology in which a device driver for controlling an external device (printer) acquires information on a usage status of functions of the external device, and displays setting information of frequently used functions preferentially on a display of an information processing apparatus.

### SUMMARY OF THE INVENTION

In order to solve the above problems, the information processing apparatus according to the present invention includes:

a display;

a communicator configured to be capable of establishing communication connection with each external device among a plurality of external devices; and

a processor that controls the display to display as a list display target information relating to each of a plurality of functions included in each of the external devices based on setting information of a display order,

wherein the processor is configured to,

in a case that the communication connection is established with a first external device that is one of the plurality of external devices with a first connection method, acquire usage log information for each of the functions from the first external device at a timing that the communication connection is established,

in a case that the communication connection is established with a second external device that is one of the plurality of external devices with a second connection method different from the first connection method, acquire the usage log information for each of the functions from the second external device at predetermined intervals, and

in a case that the setting information of the display order of each of the external devices is updated based on the acquired usage log information of each of the external devices, change the display order of display target information related to each of the plurality of functions of each of the external devices based on the updated setting information of the display order of each of the external devices, and display the display target information on the display as a list.

Further features of the present invention will become apparent from the following description of exemplary embodiments (with reference to the attached drawings).

### BRIEF DESCRIPTION OF THE DRAWINGS

FIG. 1 is a block diagram showing an example of a configuration of an information processing system.

FIG. 2 is a diagram showing an example of a list screen.

FIG. 3 is a diagram showing an example of a function list screen.

FIG. 4 is a diagram showing an example of a setting screen.

FIG. 5 is a diagram showing an example of a history screen.

FIG. 6 is a flowchart showing a flow of a function usage status acquisition process A executed by a controller of a part-time connection electronic timepiece.

FIG. 7 is a flowchart showing a flow of a function usage status acquisition process B executed by the controller of a constantly connected electronic timepiece.

FIG. 8 is a flowchart showing a flow of a display order change process executed by the controller of an information processing apparatus.

FIG. 9 is a flowchart showing a flow of a display order update process executed by the controller of a server.

FIG. 10A is a diagram showing an example of a priority display order table before usage log information is acquired.

FIG. 10B is a diagram showing an example of the priority display order table after the usage log information is acquired.

FIG. 11 is a diagram showing an example of a function list screen displayed based on the priority display order table shown in FIG. 10B.

### DETAILED DESCRIPTION

Hereinafter, embodiments to implement the present disclosure are described with reference to the drawings. However, various limitations that are technically preferable to execute the present disclosure are described in the embodiments below. Therefore, the technical scope of the present disclosure is not limited to the embodiments described below and the illustrated examples.

First, a configuration example of an information processing system 100 according to the present embodiment will be described.

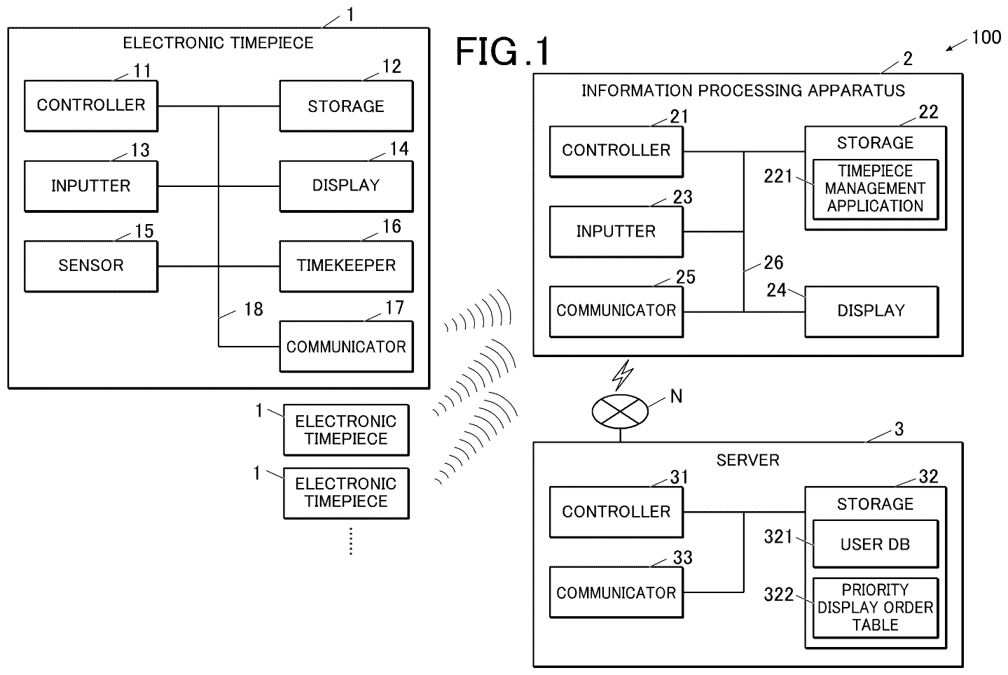

As shown in FIG. 1, the information processing system 100 includes an electronic timepiece 1, an information processing apparatus 2, and a server 3. The electronic timepiece 1 is an electronic timepiece or a smart watch, and is an external device that is managed by the information processing apparatus 2. The information processing apparatus 2 is equipped with a timepiece management application 221 and manages information about the electronic timepiece 1 owned by the user. For example, a smartphone, a tablet terminal, or a PC (Personal Computer) may be applied as the information processing apparatus 2. The server 3 stores information transmitted from the information processing apparatus 2, processes the stored information, and provides it to the information processing apparatus 2. It is assumed that the information processing apparatus 2 manages a plurality of electronic timepieces 1, but this is not particularly limited. Furthermore, the number of information processing apparatuses 2 is not particularly limited.

As shown in FIG. 1, the electronic timepiece 1 includes a controller 11, a storage 12, an inputter 13, a display 14, a sensor 15, a timekeeper 16, and a communicator 17, and each unit is connected to each other through a bus 18.

The controller 11 includes a CPU (Central Processing Unit), a RAM (Random Access Memory), and the like, and controls each unit of the electronic timepiece 1. The CPU of the controller 11 reads a designated program from among a system program and various processing programs stored in the storage 12, deploys it in the RAM, and performs various processes in cooperation with the deployed program. The processes executed by the controller 11 include, for example, processes related to various functions of the electronic timepiece 1. The functions of the electronic timepiece 1 include, but are not limited to, measurement and recording of exercise such as running, walking, biking, etc., measurement and recording of life logs, alarm, stopwatch, time correction, etc. The functions of the electronic timepiece 1 vary depending on a model of the electronic timepiece 1. In addition, the controller 11 executes a function usage status acquisition process A or a function usage status acquisition process B, which will be described later, depending on a connection method with the information processing apparatus 2 (part-time connection or constant connection).

The controller 11 may include a plurality of CPUs. The plurality of processes executed by the controller 11 in the present embodiment may be executed by the plurality of CPUs. In this case, the plurality of CPUs may be involved in a common process. Alternatively, the plurality of CPUs may independently execute different processes in parallel.

The storage 12 is configured with a non-volatile memory or the like, and stores programs, data, and the like. The storage 12 is not limited to being provided inside the electronic timepiece 1, and may include an external storage medium that can be attached to and detached from the electronic timepiece 1.

For example, the storage 12 stores the system program of the electronic timepiece 1, programs for executing processes related to various functions, and programs for executing various processes including the function usage status acquisition process A or function usage status acquisition process B described below. The storage 12 also stores a model ID for identifying a model of the electronic timepiece 1 (its own device). The storage 12 also stores usage log information for each function (usage log information for each function). The usage log information includes information on a number of times a function is used and duration that a function is used. The storage 12 also stores usage history information of a time setting function. Examples of the usage history information of the time setting function include, but are not limited to, date and time when the time was set, and region (country) information. A storage period for the usage history information of the time setting function varies depending on the model of the electronic timepiece 1. For example, in general models, only the most recent usage history information is stored, whereas in some high-end models, all past usage history information is stored.

The inputter 13 accepts input from the outside, such as handling by a user. The inputter 13 includes, for example, a crown and a push button switch, and outputs signals corresponding to the handling of these to the controller 11. Alternatively, the inputter 13 may be configured with a touch screen.

The display 14 is configured with a display device such as an LCD (Liquid Crystal Display) or an OLED (Organic Light Emitting Diode), and performs display based on control operation of the controller 11.

The sensor 15 is configured with at least one of an acceleration sensor, an angular velocity sensor, a heart rate meter, a thermometer, an altimeter, and a GPS (Global Positioning System) sensor. The sensor 15 acquires measurement information such as acceleration, angular velocity, heart rate, body temperature, altitude, current location, and the like, and outputs the above to the controller 11.

The timekeeper 16 includes an oscillator circuit, a frequency divider circuit, a timekeeper circuit, etc. The timekeeper 16 measures the current date and time and outputs the measured result to the controller 11.

The communicator 17 performs communication control for communicating with external devices such as the information processing apparatus 2 by a predetermined communication method such as Bluetooth (registered trademark).

As shown in FIG. 1, the information processing apparatus 2 includes a controller 21, a storage 22, an inputter 23, a display 24, and a communicator 25, and each unit is connected to each other through a bus 26.

The controller 21 is configured with a CPU, a RAM, etc., and controls each part of the information processing apparatus 2. The CPU of the controller 21 reads a designated program from among the system program and various application programs stored in the storage 22, deploys it in the RAM, and performs various processes in cooperation with the deployed program. The controller 21 may include a plurality of CPUs. The plurality of processes executed by the controller 21 of the present embodiment may be executed by the plurality of CPUs. In this case, the plurality of CPUs may be involved in a common process. Alternatively, the plurality of CPUs may independently execute different processes in parallel.

The storage 22 includes a nonvolatile semiconductor memory, a hard disk drive (HDD), or the like. The storage 22 is not limited to being provided inside the information processing apparatus 2, and may include an external storage medium that can be attached to and detached from the information processing apparatus 2. An example of such external storage medium may be a memory card or the like.

The storage 22 stores the system program of the information processing apparatus 2, various application programs, and data necessary for executing the programs. For example, the storage 22 stores a timepiece management application 221 for managing the electronic timepiece 1 owned by the user.

The storage 22 also stores user registration information of the user of the timepiece management application 221. The user registration information includes, for example, a user ID, password, user name, age, gender, place of residence (prefecture, etc.), the model ID of the electronic timepiece 1 registered as a target for management by the timepiece management application 221, and the date of registration.

The storage 22 also stores setting information (information indicating a display order (priority display order)) for a display order of display target information for each of the plurality of functions included in the electronic timepiece 1 managed by the timepiece management application 221. The display target information is information related to each of the multiple functions included in the electronic timepiece 1 that are displayed in a list on a function list screen 242 (here, function items (function names)). When the timepiece management application 221 is first used, a default setting state is stored as the setting information of the display order.

The storage 22 also stores usage history information of the time setting function for each electronic timepiece 1 managed by the timepiece management application 221 in association with the model ID.

The storage 22 also stores information on the connection method (constant connection or part-time connection) of each electronic timepiece 1 that can be managed by the timepiece management application 221 in association with the model ID of the electronic timepiece 1.

The inputter 23 includes a keyboard including various keys and a pointing device such as a mouse or a touch screen attached to the display 24. The inputter 23 outputs to the controller 21 a key input signal corresponding to a key input by handling by the user and a signal of handling on the screen.

The display 24 is configured with a display device such as a liquid crystal display or an organic electroluminescence (EL) display, and performs display based on the control operation of the controller 21.

The communicator 25 performs communication control for communicating with an external device using a wireless LAN such as Wi-Fi (registered trademark), a communication network N including a mobile phone communication network and the Internet, or Bluetooth (registered trademark), or the like. According to this embodiment, the communicator 25 communicates with the electronic timepiece 1 via Bluetooth (registered trademark) or the like, and communicates with the server 3 via the communication network N.

The server 3 includes a controller 31, a storage 32, a communicator 33, and the like.

The controller 31 is configured with a CPU, a RAM, etc., and controls each part of the server 3. The CPU of the controller 31 reads a designated program from among the system program and various application programs stored in the storage 32, deploys it in the RAM, and performs various processes in cooperation with the deployed program.

The storage 32 is composed of a non-volatile semiconductor memory, a HDD, or the like. The storage 32 is not limited to being built into the server 3, and may include an external storage medium that is detachable from the server 3.

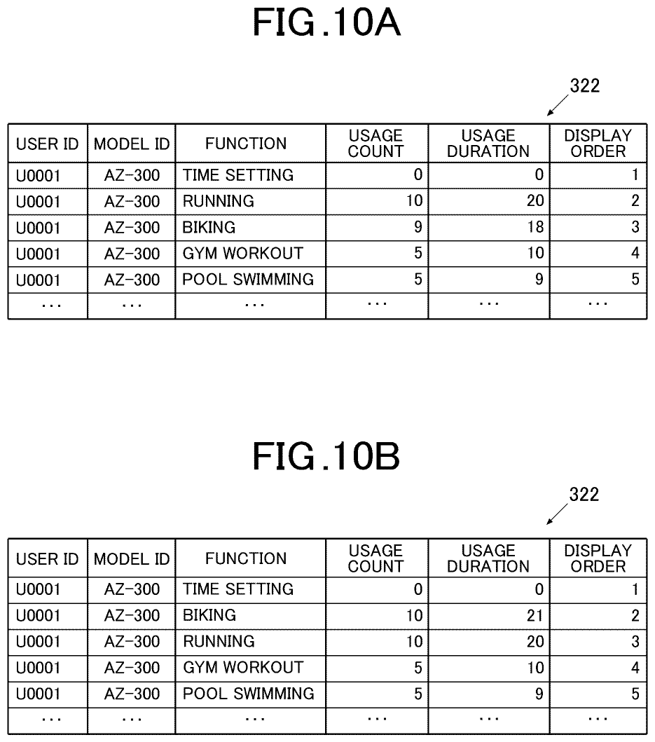

The storage 32 stores a user DB (Data Base) 321, a priority display order table 322, and the like. The user DB 321 is a DB that stores user registration information of the user of the timepiece management application 221. The priority display order table 322 is a table that stores the usage log information for each function of the electronic timepiece 1 managed by the timepiece management application 221 in association with the display order. The priority display order table 322 includes items such as user ID, model ID, function, number of uses, duration of use, and display order, as shown in, for example, FIG. 10A and FIG. 10B.

The communicator 33 communicates with the information processing apparatus 2 via the communication network N.

Next, the operation of each device constituting the information processing system 100 according to the present embodiment will be described.

In the information processing apparatus 2, when an instruction to start the timepiece management application 221 is given via the inputter 23, the controller 21 performs login authentication and starts the timepiece management application 221. Next, the controller 21 performs the following process in cooperation with the timepiece management application 221.

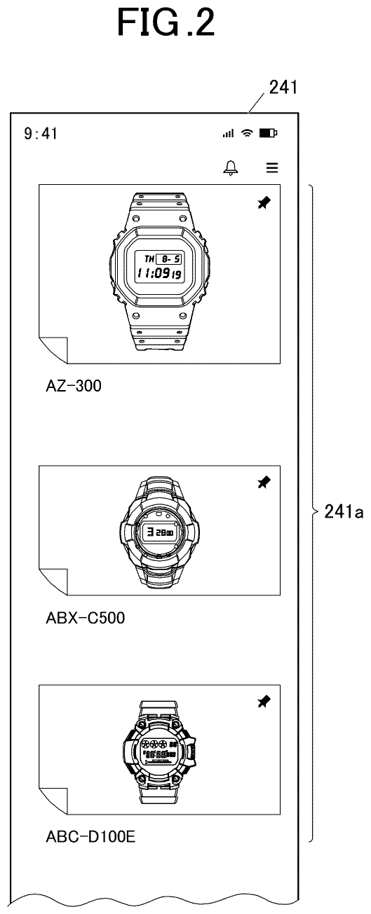

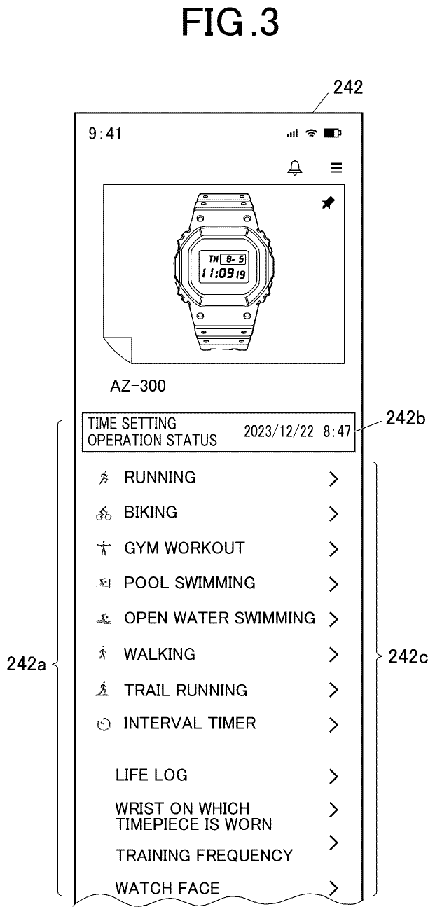

First, the controller 21 causes the display 24 to display a list screen 241. As shown in FIG. 2, the list screen 241 displays a list (list of models) 241a of the electronic timepieces 1 owned by the user. When the electronic timepiece 1 as a display target is selected from the list 241a of the electronic timepieces 1 by handling the inputter 23, the controller 21 causes the display 24 to display the function list screen 242 of the selected model of the electronic timepiece 1. As shown in FIG. 3, the function list screen 242 displays a list 242a of display target information (function items) relating to each of the multiple functions included in the selected electronic timepiece 1. When any function is selected from the function list screen 242 by handling the inputter 23, the controller 21 causes the display 24 to display a setting screen 243 or a history screen 244 relating to the selected function.

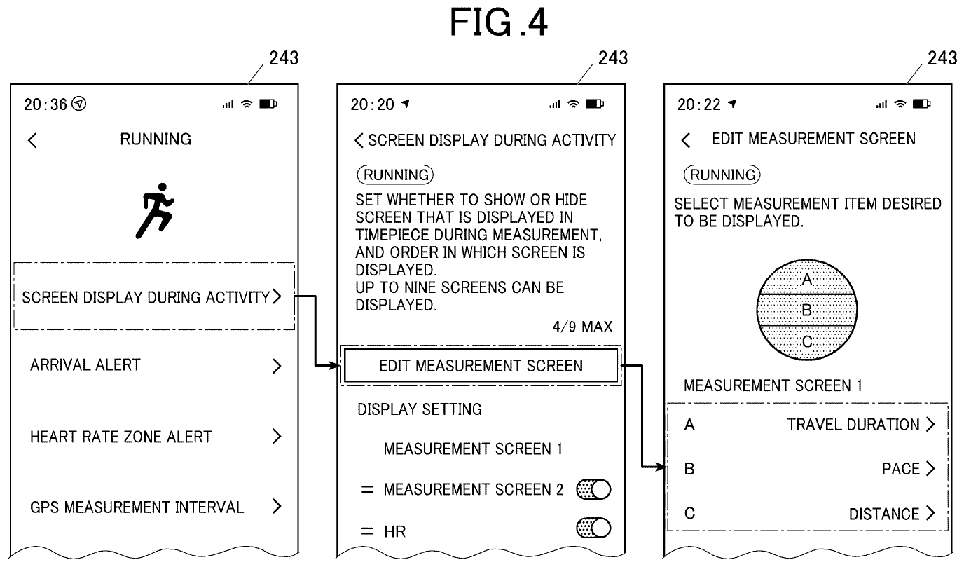

As shown in FIG. 4, the setting screen 243 is a screen for making various settings related to a selected function of the selected electronic timepiece 1. FIG. 4 shows an example of the setting screen 243 when the selected function is RUNNING. For example, in a state connected to the selected electronic timepiece 1, as shown in FIG. 4, when “Screen display during activity” and “Edit measurement screen” are selected as items to be set, and measurement items to be displayed are selected, the controller 21 stores the selected setting contents (setting information) in the storage 22 and transmits the setting information to the selected electronic timepiece 1 to reflect the setting contents. The information that can be set in the electronic timepiece 1 may differ depending on the model. Therefore, the controller 21 may display the setting screen 243 in a different display manner depending on the model.

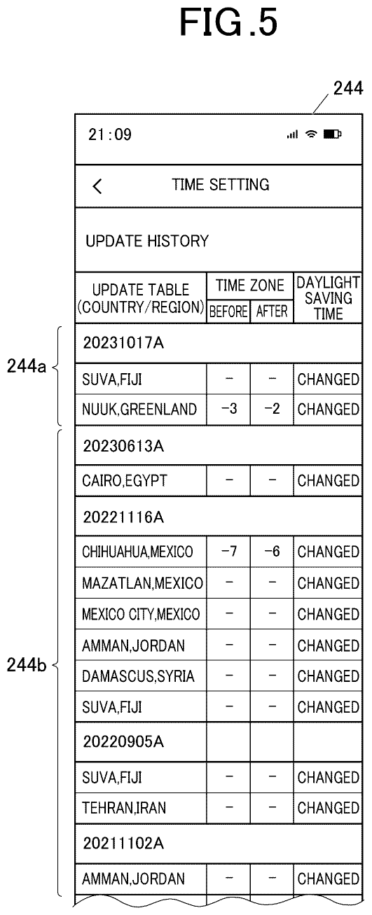

The history screen 244, as shown in FIG. 5, is a screen for displaying usage history information of a selected function in a selected electronic timepiece 1, etc. FIG. 5 shows the history screen 244 when the selected function is time setting. As shown in FIG. 5, the time setting history screen 244 displays usage history information of the time setting function. For example, the time setting history screen 244 displays the latest time setting history information 244a (date and time (“20231017A” in FIG. 5) and region information (“Suva. Fiji” in FIG. 5, etc.)). In the case of some high-end models of the electronic timepieces 1, all past time setting history information (date and time and region information) 244b is displayed. In this way, the history screen 244 is displayed in a different display manner depending on the model.

Here, the function items displayed in the list 242a on the function list screen 242 include a fixed display item 242b that is displayed at a fixed position and a variable display item 242c that is displayed in variable display positions. The fixed display item 242b is the item which is not a target of display order change. The fixed display item 242b is displayed with priority over the variable display item 242c. According to the present embodiment, as shown in FIG. 3, “set time” is displayed as the fixed display item 242b. The variable display item 242c is an item which is a target of the display order change. The variable display item 242c is displayed in such a way that the more frequently used items are displayed closer to the top based on the usage log information for each function used by the user. That is, on the function list screen 242, the item with the higher display priority order is displayed closer to the top based on the display order setting information based on the usage log information acquired from the electronic timepiece 1.

Incidentally, the electronic timepieces 1 that can be managed by the timepiece management application 221 include a plurality of electronic timepieces 1 with different connection methods. According to the present embodiment, the electronic timepiece 1 that can be managed by the timepiece management application 221 includes a first timepiece (first external device) that connects (communicatively connects) to the information processing apparatus 2 using a first connection method, and a second timepiece (second external device) that connects to the information processing apparatus 2 using a second connection method. The first connection method is a connection method (part-time connection) in which the electronic timepiece 1 connects to the information processing apparatus 2 automatically at predetermined duration intervals or manually, and the connection is disconnected when the necessary communication ends. The second connection method is a connection method in which, once the connection is established, the connection state is maintained (constantly connected). As described above, when displaying the function list screen 242 of the electronic timepiece 1 as the display target from among the plurality of electronic timepieces 1 with different connection methods, the information processing apparatus 2 needs to acquire the usage log information at an appropriate timing in accordance with the connection method of the electronic timepiece 1 and change the display order of the variable display items 242c. Otherwise, it is not possible to display the variable display items 242c in the display order according to the usage status of the functions. For example, if the constantly connected electronic timepiece 1 acquires usage log information and updates the display order only when connected to the information processing apparatus 2, as is the case with a part-time connected electronic timepiece 1, the subsequent usage of functions during the constant connection will no longer be reflected in the display order.

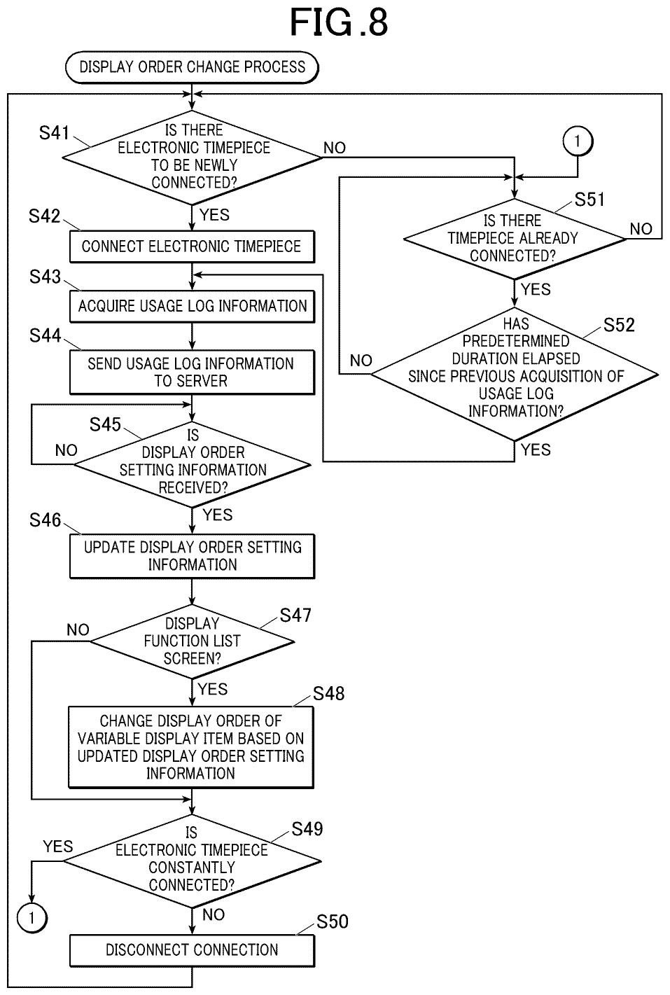

Therefore, the controller 21, in cooperation with the timepiece management application 221, executes a display order change process (see FIG. 8) described below. The controller 21 connects to the electronic timepiece 1 and acquires the usage log information according to the connection method of the electronic timepiece 1. With this, it is possible to display the variable display item 242c in the display order that appropriately reflects the user's usage status of the functions.

The operations of the electronic timepiece 1, the information processing apparatus 2, and the server 3 will now be described.

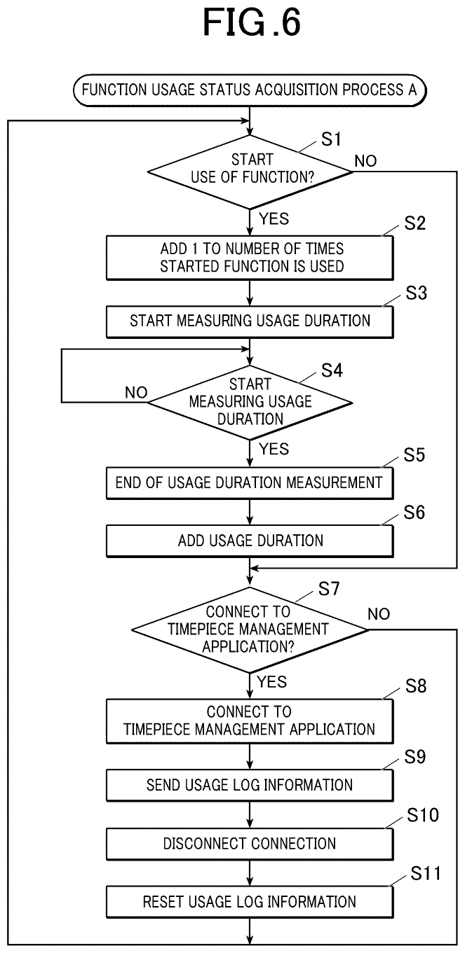

First, with reference to FIG. 6, the function usage status acquisition process A executed by the controller 11 in the electronic timepiece 1 in which the connection method is the part-time connection will be described. The function usage status acquisition process A is executed by the controller 11 in cooperation with the program stored in the storage 12 when the power supply of the electronic timepiece 1 is turned on.

In the function usage status acquisition process A, first, the controller 11 determines whether or not the use of any one of the plurality of functions has started (step S1). For example, when the user handles the inputter 13 to instruct a transition to the mode in which any function is used, the controller 11 determines that use of the instructed function has started.

If it is determined that the use of any of the functions has not started (step S1; NO), the controller 11 proceeds to step S7.

If it is determined that the use of any function has started (step S1; YES), the controller 11 adds 1 to the number of uses of the function that has started to be used in the usage log information stored in the storage 12 (step S2). Furthermore, the controller 11 starts measuring the usage duration of the function that has started to be used (step S3).

Next, the controller 11 determines whether or not the use of the function has ended (step S4). For example, when the user handles the inputter 13 to instruct the end of the function that is being used, the controller 11 determines that the use of the function has ended. If it is determined that the use of the function has not ended (step S4; NO), the controller 11 returns the process to step S4.

If it is determined that the use of the function has ended (step S4; YES), the controller 11 ends the measurement of the usage duration of the function (step S5). Then, the controller 11 adds the measured usage duration to the usage duration of the function in which the use has ended in the usage log information stored in the storage 12 (step S6), and proceeds to step S7.

In step S7, the controller 11 determines whether or not to connect (communicate) with the timepiece management application 221 of the information processing apparatus 2 (hereinafter, timepiece management application 221) (step S7). The controller 11 determines to connect to the timepiece management application 221 when an instruction to connect to the timepiece management application 221 is made by handling the inputter 13 or when it becomes predetermined time. The predetermined times are, for example, 0:00, 6:00, 12:00, 18:00, that is, a certain time and the time every six hours after that certain time. If the above is not the case, it is determined not to connect to the timepiece management application 221.

If it is determined not to connect to the timepiece management application 221 (step S7; NO), the controller 11 returns to step S1.

If it is determined to connect to the timepiece management application 221 (step S7; YES), the controller 11 connects to the timepiece management application 221 via the communicator 17 (step S8). According to the present embodiment, the timepiece management application 221 is connected via BLE (Bluetooth (registered trademark) Low Energy). Next, the controller 11 transmits the usage log information and the model ID stored in the storage 12 to the timepiece management application 221 via the communicator 17 (step S9).

According to the present embodiment, even if there is no acquisition request for the usage log information from the timepiece management application 221, the electronic timepiece 1 automatically sends the usage log information of all functions to the timepiece management application 221. However, the electronic timepiece 1 may send the usage log information to the timepiece management application 221 in response to the acquisition request for the usage log information from the timepiece management application 221. In addition, there may be a function for transmitting the usage log information from the electronic timepiece 1 to the timepiece management application 221 in response to the acquisition request from the timepiece management application 221, and a function for automatically transmitting the usage log information from the electronic timepiece 1 to the timepiece management application 221 even when no acquisition request is received from the timepiece management application 221.

Then, the controller 11 disconnects the connection with the timepiece management application 221 via the communicator 17 (step S10), resets the usage log information stored in the storage 12 (step S11), and returns to step S1. For example, the controller 11 resets the number of uses and the usage duration in the usage log information to zero.

The controller 11 executes the repeatedly The controller processes of steps S1 to S11 while the power of the electronic timepiece 1 is on.

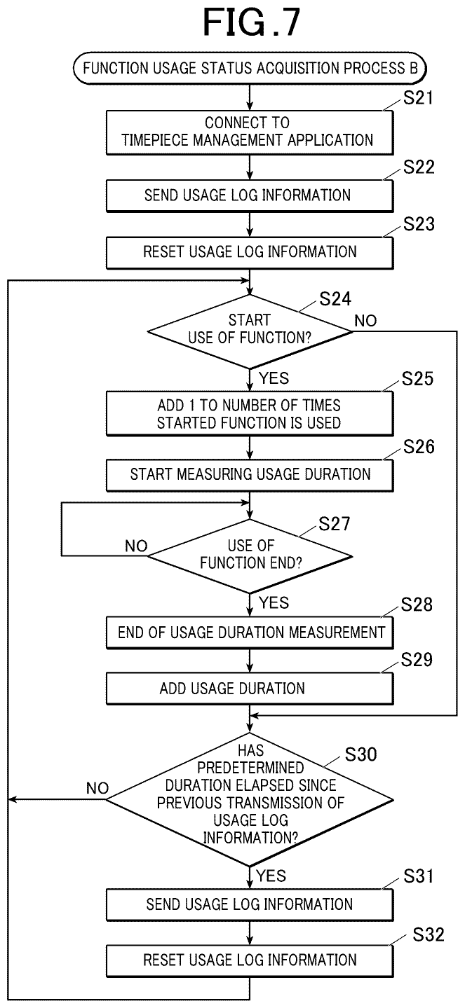

Next, with reference to FIG. 7, the function usage status acquisition process B executed by the controller 11 in the electronic timepiece 1 in which the connection method is the constant connection will be described. The function usage status acquisition process B is executed by the controller 11 in cooperation with the program stored in the storage 12 when the power supply of the electronic timepiece 1 is turned on.

In the function usage status acquisition process B, first, the controller 11 connects to the timepiece management application 221 of the information processing apparatus 2 through the communicator 17 (step S21). According to the present embodiment, the timepiece management application 221 of the information processing apparatus 2 is connected via BLE (Bluetooth (registered trademark) LOW Energy).

Next, the controller 11 transmits the usage log information and the model ID stored in the storage 12 to the timepiece management application 221 via the communicator 17 (step S22). Next, the controller 11 resets the usage log information stored in the storage 12 (step S23).

Next, the controller 11 determines whether or not the use of any of the plurality of functions has started (step S24). For example, when the user handles the inputter 13 to instruct the transition to the mode in which any function is executed, the controller 11 determines that the use of the instructed function has started.

If it is determined that the use of any of the functions has not started (step S24; NO), the controller 11 proceeds to step S30.

If it is determined that the use of any function has started (step S24; YES), the controller 11 adds 1 to the number of uses of the function that has started to be used in the usage log information stored in the storage 12 (step S25). Furthermore, the controller 11 starts measuring the usage duration of the function that has started to be used (step S26).

Next, the controller 11 determines whether or not the use of the function has ended (step S27). For example, when the user handles the inputter 13 to instruct the end of the function that is being used, the controller 11 determines that the use of the function has ended.

If it is determined that the use of the function has not ended (step S27; NO), the controller 11 returns the process to step S27.

If it is determined that the use of the function has ended (step S27; YES), the controller 11 ends the measurement of the usage duration of the function (step S28). Then, the controller 11 adds the measured usage duration to the usage duration of the function in which the use has ended in the usage log information stored in the storage 12 (step S29), and proceeds to step S30.

In step S30, the controller 11 determines whether or not a predetermined duration (for example, six hours) has elapsed since the previous transmission of the usage log information (step S30). If it is determined that the predetermined duration has not elapsed since the previous transmission of the usage log information (step S30; NO), the controller 11 returns to step S24.

If it is determined that the predetermined duration has elapsed since the last transmission of usage log information (step S30; YES), the controller 11 transmits the usage log information and model ID stored in the storage 12 to the timepiece management application 221 via the communicator 17 (step S31). Here, since the electronic timepiece 1 and the timepiece management application 221 are constantly connected, this means that the above are currently connected. After the transmission, the controller 11 resets the usage log information stored in the storage 12 (step S32), and the process returns to step S24.

The controller 11 repeatedly executes the processes of steps S24 to S32 while the power of the electronic timepiece 1 is on. If the connection between the electronic timepiece 1 and the timepiece management application 221 is cut off for some reason, the controller 11 executes the function usage status acquisition process B again.

Next, a display order change process executed by the controller 21 in the information processing apparatus 2 will be described with reference to FIG. 8. The display order change process is executed by the controller 21 in cooperation with the timepiece management application 221 when the timepiece management application 221 is started.

In the display order change process, first, the controller 21 determines via the communicator 25 whether or not there is the electronic timepiece 1 that is attempting to newly connect to the timepiece management application 221 (step S41). If it is determined that there is the new electronic timepiece 1 attempting to connect to the timepiece management application 221 (step S41; YES), the controller 21 establishes a communication connection with the electronic timepiece 1 via the communicator 25 (step S42), and acquires the model ID and usage log information from the electronic timepiece 1 via the communicator 25 (step S43). The processes in steps S42 to S43 corresponds to the processes in steps S8 to S9 in FIG. 6 and steps S21 to S22 in FIG. 7.

Next, the controller 21 associates the user ID and model ID (model ID of the electronic timepiece 1) with the acquired usage log information and transmits the information to the server 3 via the communicator 25 (step S44). Next, the controller 21 determines whether or not the display order setting information has been received from the server 3 by the communicator 25 (step 45).

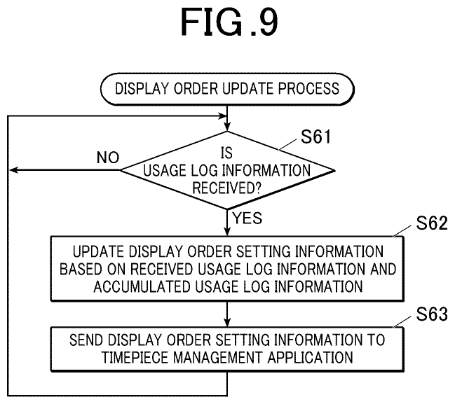

Here, when the server 3 receives the usage log information from the information processing apparatus 2, the server 3 executes a display order update process (FIG. 9). Based on the transmitted usage log information, the server 3 updates the usage log information and display order that are in the priority display order table 322 and that are corresponded to the user ID and model ID transmitted in association with the usage log information. Then, the server 3 transmits the updated display order setting information to the timepiece management application 221.

If it is determined that the display order setting information has not been received from the server 3 by the communicator 25 (step S45; NO), the controller 21 returns to step S45. If the controller 21 determines that the communicator 25 has received the display order setting information from the server 3 (step S45; YES), the controller 21 updates the display order setting information stored in the storage 22 with the received display order setting information (step S46).

Next, the controller 21 determines whether or not there has been an instruction to display the function list screen 242 on the display 24 (step S47). For example, if the electronic timepiece 1 as the display target is selected from the list 241a of electronic timepieces 1, the controller 21 determines that an instruction to display the function list screen 242 on the display 24 has been made. If it is determined that there is no instruction to display the function list screen 242 on the display 24 (step S47; NO), the controller 21 proceeds to step S49. If it is determined that there is an instruction to display the function list screen 242 on the display 24 (step S47; YES), the controller 21 rearranges the order of the variable display items 242c on the function list screen 242 based on the updated display order setting information and displays the above on the display 24 (step S48). Then, the controller 21 proceeds to step S49. When displaying the function list screen 242, the controller 21 refers to the display order setting information stored in the storage 22, and displays the variable display items 242c in the display order based on the display order setting information.

In step S49, the controller 21 determines whether the currently connected electronic timepiece 1 is the constantly connected timepiece (step S49). If it is determined that the currently connected electronic timepiece 1 is not the constantly connected timepiece, i.e., the part-time connected timepiece (step S49; NO), the controller 21 disconnects the connection in response to a request from the electronic timepiece 1 (step S50) and returns to step S41.

If it is determined that the currently connected electronic timepiece 1 is a constantly connected timepiece (step S49; YES), the controller 21 proceeds to step S51.

On the other hand, if it is determined in step S41 that there is no electronic timepiece 1 to be newly connected (step S41; NO), the controller 21 proceeds to step S51.

In step S51, the controller 21 determines whether or not the electronic timepiece 1 is already connected (step S51). In step S51, the controller 21 determines whether or not there is the electronic timepiece 1 already connected for communication via BLE (Bluetooth (registered trademark) Low Energy). If it is determined that no electronic timepiece 1 is already connected (step S51; NO), the controller 21 returns to step S41.

If it is determined that the electronic timepiece 1 is already connected (step S51; YES), the controller 21 determines whether a predetermined duration has elapsed since the previous acquisition of the usage log information (step S52). If it is determined that the predetermined duration has not elapsed since the previous acquisition of the usage log information (step S52; NO), the controller 21 returns to step S51. If it is determined that the predetermined duration has elapsed since the previous acquisition of the usage log information (step S52; YES), the controller 21 proceeds to step S43 and executes the processes of steps S43 to S49.

That is, for the part-time connection electronic timepiece 1, the controller 21 acquires the usage log information for each function from the electronic timepiece 1 at the timing that the connection is established, and transmits the usage log information to the server 3. When the controller 21 receives the setting information of the display order from the server 3, the controller 21 updates the setting information of the display order stored in the storage 22 with the received setting information of the display order. If there is an instruction to display the function list screen 242 on the display 24, the controller 21 changes the display of the variable display items 242c based on the setting information of the display order and displays the above on the display 24. The controller 21 then disconnects the connection with the electronic timepiece 1.

On the other hand, for the constantly connected electronic timepiece 1, at the timing that the connection is established, the controller 21 acquires the usage log information for each function from the electronic timepiece 1, transmits the usage log information to the server 3, acquires the display order setting information from the server 3, and updates the display order setting information. If there is an instruction to display the function list screen 242 on the display 24, the display of the variable display item 242c is changed based on the display order setting information and displayed on the display 24. Thereafter, the controller 21 does not disconnect the connection with the electronic timepiece 1, and repeats the above-mentioned processes of acquiring the usage log information from the electronic timepiece 1, transmitting the usage log information to the server 3, acquiring the display order setting information from the server 3, updating the display order setting information, and changing the display order at predetermined duration intervals from the previous transmission of the usage log information.

In this way, the information processing apparatus 2 can acquire the usage log information at appropriate times in accordance with the connection method of the electronic timepiece 1 and reflect the above in the display order for the function of the function list screen. Therefore, the display target information relating to each of the functions included in the plurality of electronic timepieces 1 having different connection methods can be displayed in an appropriate display order.

Next, the display order update process executed by the controller 31 of the server 3 will be described with reference to FIG. 9. The display order update process is executed by the controller 31 in cooperation with the program stored in the storage 32 when the power supply of the server 3 is turned on.

First, the controller 31 determines whether or not the communicator 33 has received the usage log information from the timepiece management application 221 (step S61). If it is determined that the communicator 33 has not received the usage log information from the timepiece management application 221 (step S61; NO), the controller 31 returns to step S61.

If it is determined that the usage log information has been received from the timepiece management application 221 (step S61; YES), the controller 31 updates the display order setting information based on the received usage log information and the usage log information stored in the priority display order table 322 of the storage 32 (step S62).

In step S62, first, the controller 31 extracts from the priority display order table 322 a record corresponding to the user ID and model ID associated with the received usage log information, and adds the number of uses and usage duration of each function in the received usage log information to the number of uses and usage duration of each function in the extracted record. Next, the controller 31 updates the display order of each function after the addition based on the number of times of use and the duration of use. For example, the controller 31 first sorts the records after the addition in order starting from the larger number in the number of times of use. If there are functions that have been used the same number of times, the controller 31 determines the display order by sorting the function with the longer usage duration to be higher. Then, the controller 31 updates the display order information (display order setting information) in the priority display order table 322.

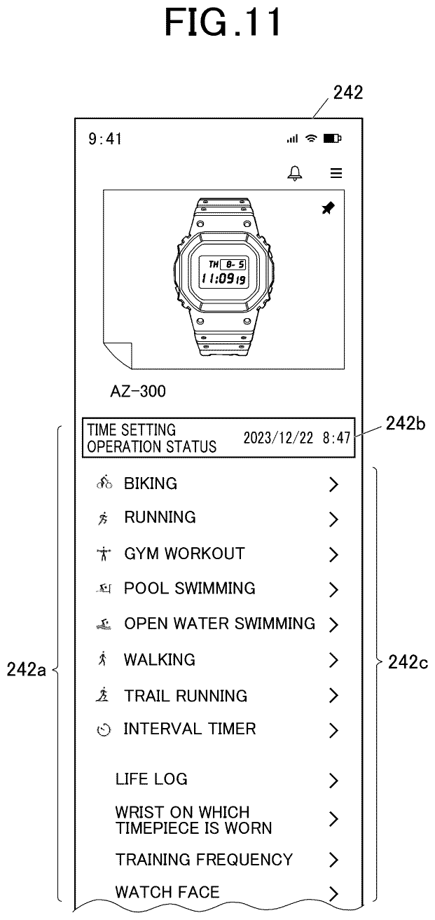

For example, when the priority display order table 322 is in the state shown in FIG. 10A, if the usage log information is received in which the number of uses of BIKING has been increased by one and the usage duration has been increased by three hours, the number of uses of BIKING in FIG. 10A will be incremented by +1 and the usage duration will be incremented by +3. With this, the number of times BIKING and RUNNING have been used becomes the same, 10 times, and the usage duration of BIKING exceeds that of RUNNING, so that the display order of BIKING and RUNNING is switched, as shown in FIG. 10B. As a result, for example, the display order of the variable display items 242c on the function list screen 242 is changed from the display order in which RUNNING is at the top as shown in FIG. 3 to the display order in which BIKING is at the top as shown in FIG. 11. In this way, the more frequently the function is used by the user, the higher it is displayed in the display order, so that the function list screen 242 that is easy for the user to use can be displayed. Since the time setting function is the fixed display item 242b, it is displayed first in the display order regardless of the number of times it is used or the duration of use. When there are the plurality of fixed display items 242b, the display order is determined in advance among the fixed display items 242b.

Then, the controller 31 transmits the setting information of the display order to the timepiece management application 221 via the communicator 33 (step S63), and returns to the process of step S61. The controller 31 repeatedly executes the processes of steps S61 to S63 while the power supply of the server 3 is on.

The information stored in the priority display order table 322 is reset at predetermined intervals (for example, once a month). This allows the display order of the display setting information for each of the plurality of functions of the electronic timepiece 1 displayed on the function list screen 242 to be the display order based on the usage status of each function over the most recent predetermined period.

As described above, if the controller 21 of the information processing apparatus 2 is communicatively connected to the electronic timepiece 1 using the first connection method (part-time connection), the controller 21 acquires the usage log information for each function from the electronic timepiece 1 at the timing that the connection is established. Furthermore, if the controller 21 is communicatively connected to the electronic timepiece 1 using the second connection method (constant connection), the controller 21 acquires the usage log information for each function from the electronic timepiece 1 at predetermined intervals. Then, if the display order setting information of the electronic timepiece 1 is updated based on the acquired usage log information, the controller 21 changes the display order of the display target information (function items) for each of the plurality of functions displayed as a list on the function list screen 242 based on the updated display order setting information. For example, the information processing apparatus disclosed in the aforementioned JP 2016-42304 does not acquire the information of the usage status from the plurality of external devices with different connection methods, such as external devices that are constantly connected and external devices that are part-time connected. For this reason, it is not possible to acquire the usage status of each function at an appropriate timing in correspondence with each of the plurality of external devices having different connection methods and to reflect this in the display order of the functions. In contrast, the information processing apparatus 2 of the present disclosure can display the display target information relating to each of the functions included in the plurality of electronic timepieces 1 with different connection methods in an appropriate display order.

The usage log information includes information on the number of times the function has been used and the duration of use. Therefore, the display target information relating to each of the functions included in the plurality of electronic timepieces 1 with different connection methods can be displayed in an appropriate display order according to the number of times and the duration of use of the function.

Furthermore, when the controller 21 is communicatively connected to the electronic timepiece 1 using the second connection method, the controller 21 acquires the usage log information at the timing when the communication connection with the electronic timepiece 1 is established, so that the display target information relating to each of the functions included in the electronic timepiece 1 can be displayed in an appropriate order at the timing when the communication connection with the electronic timepiece 1 is established.

The display target information for each of the plurality of functions includes the variable display item 242c which is information that is to be the target in which the display order is changed, and the fixed display item 242b which is information that is not the target in which the display order is changed. The controller 21 controls the display 24 to display the fixed display item 242b with priority over the variable display item 242c. Therefore, it is possible to display information that should be displayed with priority regardless of the usage situation in a prioritized manner.

Furthermore, when the controller 21 causes the display 24 to display detailed information on display target information (function items) relating to each of a plurality of functions, the controller 21 causes the display to be performed in a different display format depending on the model of the electronic timepiece 1. Therefore, for example, the setting screen for the function specified from the list can be changed according to the contents that can be set in each model, and the number of time setting history information displayed can be changed according to the model.

In addition, the controller 31 of the server 3 updates the display order setting information based on the number of times each function has been used within a predetermined period, and if there are functions that have been used the same number of times, updates the display order setting information based on the usage duration of the function. Therefore, the display target information for each function included in the electronic timepiece 1 can be displayed in an appropriate display order according to the number of times the function has been used, and, if there are functions that have been used the same number of times, according to the duration that the function has been used.

The description according to the above embodiments are merely a suitable example of the present invention and the present invention is not limited to the above.

For example, in the above embodiment, after the function item is selected from the function list screen 242, the setting screen 243 or history screen 244 related to that function is displayed. However, the screen displayed after the function item is selected is not limited to the setting screen or history screen as long as it is related to the selected function.

In addition, in the above embodiment, the controller 21 updates the display order setting information stored in the storage 22 based on the display order setting information transmitted from the server 3, and if there is an instruction to display the function list screen 242 on the display 24, the controller 21 rearranges the order of the variable display items 242c on the function list screen 242 based on the updated display order setting information and displays the above on the display 24. However, the change in the display order may be reflected when the screen of the function list screen 242 is updated. In addition, if the function list screen 242 is being displayed when the display order setting information is updated, the order of the variable display items 242c on the function list screen 242 may be rearranged and displayed based on the updated display order setting information.

In addition, according to the above embodiment, the accumulation of usage log information and the updating of the display order of the functions are performed by one server 3, but the accumulation of the usage log information and the updating of the display order of functions may also be performed by multiple servers, for example, by performing the accumulation of the usage log information and the updating of the display order of functions on separate servers.

According to the above embodiment, the server 3 accumulates the usage log information and updates the display order setting information. However, the timepiece management application 221 of the information processing apparatus 2 may also perform these operations. In other words, the usage log information and the display order setting information may be stored in the storage 22, and the controller 21 may work in cooperation with the timepiece management application 221 to accumulate the usage log information in the storage 22 and update the display order setting information.

In the above embodiment, communication between the electronic timepiece 1 and the information processing apparatus 2 is performed using Bluetooth, but this is not limited to this.

Furthermore, in the above embodiment, the external device of the present invention is described as being the electronic timepiece 1, but the external device is not limited to an electronic timepiece and may be other electronic devices.

According to the above description, a semiconductor memory or HDD can be used as the computer readable storage medium storing the program regarding the above disclosure but the examples are not limited to the above. As the computer readable medium, a portable recording/storage medium, such as a CD-ROM, can also be used. A carrier wave is also applied as a medium providing the program data according to the present invention via a communication line.

Although embodiments and the modification examples of the present disclosure have been described above, the scope of the present disclosure is not limited to the embodiments and modification examples described above, but includes the scope of the invention described in the claims and their equivalents.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising:
a display;
a communicator configured to be capable of establishing communication connection with each external device among a plurality of external devices; and
a processor that controls the display to display as a list display target information relating to each of a plurality of functions included in each of the external devices based on setting information of a display order,
wherein the processor is configured to,
in a case that the communication connection is established with a first external device that is one of the plurality of external devices with a first connection method, acquire usage log information for each of the functions from the first external device at a timing that the communication connection is established,
in a case that the communication connection is established with a second external device that is one of the plurality of external devices with a second connection method different from the first connection method, acquire the usage log information for each of the functions from the second external device at predetermined intervals, and
in a case that the setting information of the display order of each of the external devices is updated based on the acquired usage log information of each of the external devices, change the display order of display target information related to each of the plurality of functions of each of the external devices based on the updated setting information of the display order of each of the external devices, and display the display target information on the display as a list.

2. The information processing apparatus according to claim 1, wherein the usage log information includes information on a number of times the function is used and a usage duration.

3. The information processing apparatus according to claim 1, wherein the processor is configured to, in a case that the communication connection with the second external device is established with the second connection method, acquire the usage log information at a timing that the communication connection with the second external device is established.

4. The information processing apparatus according to claim 1, wherein the display target information relating to each of the plurality of functions includes information that is a target of a change in the display order and information that is not a target of the change in the display order.

5. The information processing apparatus according to claim 4, wherein the processor is configured to display on the display the information that is not the target of the change in the display order with priority over the information that is the target of the change in the display order.

6. The information processing apparatus according to claim 4, wherein the processor is configured to, when detailed information of the display target information is displayed on the display, the detailed information is displayed in a different display manner depending on a model of each of the external devices.

7. The information processing apparatus according to claim 1, wherein the first connection method is a part-time connection, and the second connection method is a constant connection.

8. An information processing system comprising:
the information processing apparatus according to claim 1; and
a server configured to be capable of communicating with the information processing apparatus,
wherein,
the information processing apparatus transmits the acquired usage log information to the server, and
the server includes a storage that accumulates the usage log information, and when the server receives the usage log information from the information processing apparatus, the server updates the setting information of the display order based on the received usage log information and the usage log information stored in the storage, and transmits the updated setting information of the display order to the information processing apparatus.

9. The information processing system according to claim 8, wherein the server updates the setting information of the display order based on the number of times each of the functions is used within a predetermined period, and if there are functions with the same number of times of use, updates the setting information of the display order based on a usage duration of the function.

10. An information processing method executed by an information processing apparatus including a display, and a communicator that is configured to be capable of establishing communication connection with each external device among a plurality of external devices, the method comprising:
displaying on the display as a list display target information relating to each of a plurality of functions included in each of the external devices based on setting information of a display order;
in a case that the communication connection is established with a first external device that is one of the plurality of external devices with a first connection method, acquiring usage log information for each of the functions from the first external device at a timing that the communication connection is established,
in a case that the communication connection is established with a second external device that is one of the plurality of external devices with a second connection method different from the first connection method, acquiring the usage log information for each of the functions from the second external device at predetermined intervals, and
in a case that the setting information of the display order of each of the external devices is updated based on the acquired usage log information of each of the external devices, changing the display order of display target information related to each of the plurality of functions of each of the external devices based on the updated setting information of the display order of each of the external devices, and displaying the display target information on the display as a list.

11. The information processing method according to claim 10, wherein the usage log information includes information on a number of times the function is used and a usage duration.

12. The information processing method according to claim 10, further comprising, in a case that the communication connection with the second external device is established with the second connection method, acquiring the usage log information at a timing that the communication connection with the second external device is established.

13. The information processing method according to claim 10, wherein the display target information relating to each of the plurality of functions includes information that is a target of a change in the display order and information that is not a target of the change in the display order.

14. The information processing method according to claim 10, wherein the first connection method is a part-time connection, and the second connection method is a constant connection.

15. A non-transitory computer-readable storage medium having recorded thereon a program for causing a computer of an information processing apparatus including a display, and a communicator that is configured to be capable of establishing communication connection with each external device among a plurality of external devices, to execute the following processes:
displaying on the display as a list display target information relating to each of a plurality of functions included in each of the external devices based on setting information of a display order determined in advance;
in a case that the communication connection is established with a first external device that is one of the plurality of external devices with a first connection method, acquiring usage log information for each of the functions from the first external device at a timing that the communication connection is established,
in a case that the communication connection is established with a second external device that is one of the plurality of external devices with a second connection method different from the first connection method, acquiring the usage log information for each of the functions from the second external device at predetermined intervals, and
in a case that the setting information of the display order of each of the external devices is updated based on the acquired usage log information of each of the external devices, changing the display order of display target information related to each of the plurality of functions of each of the external devices based on the updated setting information of the display order of each of the external devices, and displaying the display target information on the display as a list.

16. The storage medium according to claim 15, wherein the usage log information includes information on a number of times the function is used and a usage duration.

17. The storage medium according to claim 15, wherein the computer executes, in a case that the communication connection with the second external device is established with the second connection method, acquiring the usage log information at a timing that the communication connection with the second external device is established.

18. The storage medium according to claim 15, wherein the display target information relating to each of the plurality of functions includes information that is a target of a change in the display order and information that is not a target of the change in the display order.

19. The storage medium according to claim 15, wherein the first connection method is a part-time connection, and the second connection method is a constant connection.
